(19) United States
(12) Patent Application Publication
(10) Pub. No.: US 2017/0182707 A1
(43) Pub. Date: Jun. 29, 2017

(54) THREE-DIMENSIONAL-PRINTING APPARATUS, AND CORRESPONDING METHOD

(71) Applicant: SOLIDO3D S.R.L., Roma (RM) (IT)

(72) Inventor: Filippo MORONI, Roma (RM) (IT)

(21) Appl. No.: 15/143,906

(22) Filed: May 2, 2016

(30) Foreign Application Priority Data
Dec. 24, 2015 (IT) 102015000087796

(51) Int. Cl. B29C 67/00; G05B 19/4099

(52) U.S. Cl. CPC B29C 67/007; B29C 67/0088; B29C 67/0085; G05B 19/4099; B33Y 10/00

(57) ABSTRACT

An apparatus for three-dimensional printing of three-dimensional products operating by solidification, through light radiation, of successive layers of a growth liquid that includes a photopolymer that can be solidified by said light radiation, the apparatus comprising a vat for growth of the print product, which is designed to contain said growth liquid, an actuating portion associated to a print surface designed to adhere to the successive layers after solidification in order to move the print product during growth in said growth vat, and a light source, which faces said bottom part, for emitting said light radiation.

The printing apparatus includes a portion configured for housing a mobile terminal set with a screen of its own facing the bottom part of said growth vat, and said photopolymer is of a type that can be solidified by the light radiation emitted by said screen, in particular by radiation in the visible range.

### TECHNICAL FIELD

The present disclosure relates to techniques for three-dimensional printing of three-dimensional products by solidification, through light radiation, of successive layers of a growth liquid that includes a photopolymer that can be solidified by said light radiation, comprising a vat for growth of the print product, which is designed to contain said growth liquid; an actuator associated to a print surface, which is designed to move the print product during growth in the growth vat after solidification by successive layers; and a light source, which emits light in the visible spectrum and faces the bottom part, for emitting said light radiation.

Various embodiments may apply to a three-dimensional-printing system, which comprises interacting with a remote server that provides three-dimensional digital models.

### TECHNOLOGICAL BACKGROUND

Known to the art are three-dimensional-printing apparatuses that carry out printing of products via three-dimensional printing of plastic material with techniques of additive deposition of plastic material extruded at thermoplastic temperature, which carry out solidification of growing sequences of layers, the profile of which corresponds to progressive sections of the print product according to the three-dimensional models stored in computers that drive the three-dimensional printing process.

In particular, three-dimensional-printing apparatuses are known that use photopolymerization techniques, which envisage exposing a vat of a growth liquid comprising a photopolymer to light radiation in a controlled way. The growth photopolymer present in the liquid state, by action of the catalyzation induced by exposure to specific light radiation, polymerizes (i.e., passes into the solid state) in the areas where it has been exposed to light. A print surface immersed in the growth vat may, for example, translate upwards or downwards, according to how the light source is positioned, allowing a new liquid growth layer to coat the layer that has just solidified. A new exposure to light is carried out according to the next section of the print product. After a given number of simple or complex iterations of exposure to light and translation, the print product or physical model with all its sections of a depth corresponding to the thickness of a single growth layer, is defined as being completed. This method in itself known is referred to, for example, as “DLP (Digital Light Processing)”. In general, the print surface can be brought onto the bottom of the growth vat at a distance from the bottom equal to the depth of one growth layer: the plane thus identified, which is called “radiating plane” is also known as “zero plane”. The layer is solidified, and then the print surface is translated by a distance equal to the depth of one growth layer, and the corresponding space is filled by new growth liquid.

In general, the above systems use a technology of projection of sequences of mask images that correspond to decomposition by equidistant parallel planes, or slices. This operation of decomposition is known as “slicing”. Each slice is converted into a two-dimensional mask image. The mask image is then projected onto the surface of the growth liquid, i.e., the solidifiable photopolymer. Thus, the light projected onto the liquid solidifies the radiated parts. Instead, the masked parts, since they lack the necessary condition of proximity to an illuminated pixel of the matrix and are consequently not radiated, remain unaltered, i.e., in the liquid state.

The light radiation employed is usually emitted by an ultraviolet source, for example, a UV beam or a raster matrix, which solidifies a path or points of the growth layer. Also known are applications of light sources in the visible spectrum, which require, as growth liquid, the use of polymeric resin photoactivated by light emitted in the visible spectrum. This polymeric resin or photopolymer may, by way of example, comprise a photo-initiator that is activated at wavelengths longer than 400 nm, this photopolymeric liquid preparation containing, for example, photo-initiators, such as aromatic phosphinoxides like bisacylphosphinoxide or a number of metallocene compounds. Compounds of this type are described, for example, in WO 2006/079788.

The light sources in the visible may be constituted by screens for displaying mask images, which, for example, basically display the cross section to be solidified via a mask image that is black where the liquid is not to be solidified and white where it is to be solidified. These apparatuses exploit an LCD matrix, which reproduces, at a given frame rate, the mask, is controlled by an external device and an external board, and is illuminated by a second backlighting LED matrix.

The known apparatuses just described present, however, some drawbacks; namely:
they call for dedicated apparatuses that require an external computer for managing the digital three-dimensional model and driving the printing steps; in particular, they call for software dedicated to post-processing of the 3D model such that the geometries can be converted into machine code, the sets of which must be supplied by the user;
the angle of incidence due to the sequence of optical elements represented by the light source—RGB LED matrix-plane of projection creates a considerable effect of blurring on account of the Gaussian interactions proper to reflected and non-absorbed light, and in particular a diffraction of the white channel, which may be recognized by looking, sideways on, the areas of black pixels of a LED screen, which become light;
the fact that the LCD technology with backlighting LED matrix is unable to guarantee an absolute black in so far as this obtained, point by point of the matrix, by a full white LED filtered by the maximum opposition of the liquid crystals since it is a technology that is unable by its very nature to turn off a single LED; in LCD technology with backlighting LED matrix the maximum power in the frequency of white (maximum irradiance) and the maximum expression of deep black, even in the condition of maximum contrast, in effect correspond to a light grey and a dark grey, and consequently this technique has a poor efficiency in the case where catalyzation is to be induced (incomplete curing) and is light polluting in the case where catalyzation is not to be induced, i.e., where the pixel should be neutral (undesired curing).

### OBJECT AND SUMMARY

The object of the embodiments described herein is to improve the potential of the apparatuses and methods according to the known art as discussed previously.

Various embodiments achieve the above object thanks to a three-dimensional-printing apparatus having the characteristics recalled in the ensuing claims. Various embodiments may refer also to corresponding three-dimensional-printing methods and likewise may refer to a computer program product, which can be loaded into the memory of at least one computer (e.g., a terminal in a network) and comprises portions of software code suitable for executing the steps of the method when the program is run on at least one computer. As used herein, the above computer program product is understood as being equivalent to a computer-readable medium containing instructions for controlling the computer system so as to co-ordinate execution of the method according to the invention. Reference to “at least one computer” is intended to emphasize the possibility of the present invention being implemented in a modular and/or distributed form. The claims form an integral part of the technical teachings provided herein in relation to the invention.

### BRIEF DESCRIPTION OF THE DRAWINGS

Various embodiments will be now described, purely by way of example, with reference to annexed drawings, in which:

FIG. 1 is a perspective view of the three-dimensional-printing apparatus as a whole;

FIG. 2 is an exploded perspective view of parts of the three-dimensional-printing apparatus of FIG. 1;

FIG. 3 is an exploded perspective view of a further part of the three-dimensional-printing apparatus of FIG. 1;

FIG. 4 shows schematically control modules of the apparatus of FIG. 1 in the context of a three-dimensional-printing architecture;

FIG. 5 shows a flowchart regarding a printing procedure of the apparatus of FIG. 1;

FIG. 6 shows a timing chart of signals sent in the framework of the printing procedure of FIG. 5; and

FIG. 7 shows a flowchart regarding a remote printing procedure of the architecture of FIG. 4.

### DETAILED DESCRIPTION

In the ensuing description numerous specific details are provided in order to enable maximum understanding of the embodiments described by way of example. The embodiments may be implemented with or without specific details, or else with other methods, components, materials, etc. In other circumstances, well-known structures, materials, or operations not are shown or described in detail so that aspects of the embodiments will not be obscured. Reference to “an embodiment” or “one embodiment” in the course of the present description is intended to indicate that a particular feature, structure, or characteristic described in connection with the embodiment is comprised in at least one embodiment. Hence, phrases such as “in an embodiment” or “in one embodiment” that may be present in various points throughout the present description do not necessarily refer to one and the same embodiment. Moreover, the particular features, structures, or characteristics may be combined in any convenient way in one or more embodiments.

The notation and references are provided herein purely for convenience of the reader and do not define the scope or the meaning of the embodiments.

In brief, the solution described herein refers to an apparatus for three-dimensional printing of three-dimensional products that operates by solidification, through light radiation, of successive growth layers, the apparatus comprising a print-drive portion, which is configured for housing a mobile-communication terminal that includes a display screen, wherein the screen is set facing the bottom part of the growth vat, the photopolymer being of a type that can be solidified by light radiation emitted by the screen, in particular by radiation in the visible range.

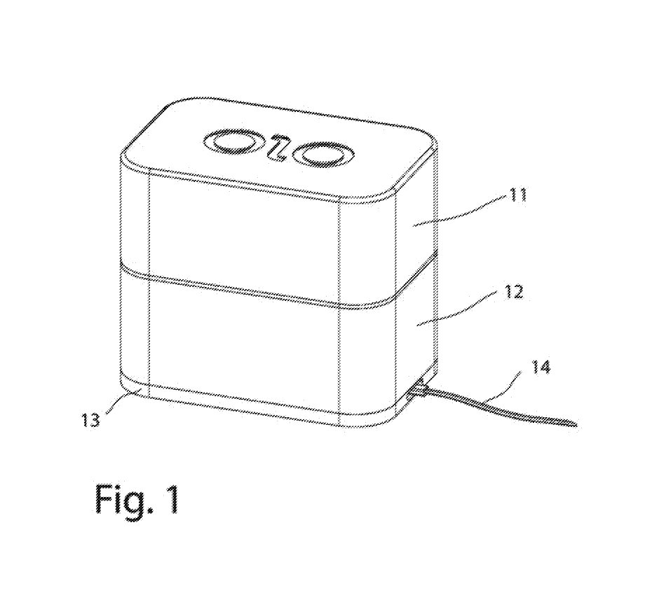

FIG. 1 shows a three-dimensional-printing apparatus 10 in perspective view in an assembled, or closed, configuration that is assumed during execution of the printing process.

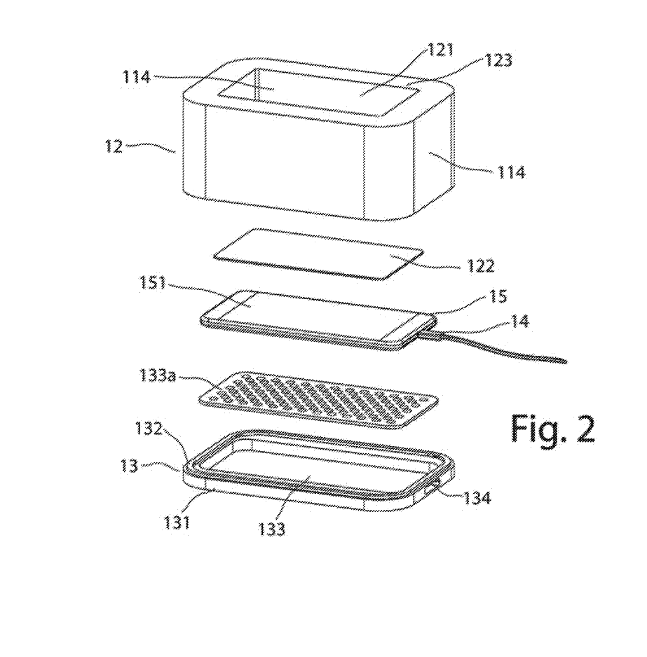

In this configuration, the printing apparatus 10 comprises a top, actuating, portion 11 fitted or stacked on a median vat portion 12, which in turn rests on a bottom drive portion 13, into which a supply cable 14 enters, which can also carry a digital signal in addition to the power supply, for example a USB cable. The bottom drive portion 13 has, in plan view, in the horizontal plane XY, the shape of a parallelogram, in particular a rectangle, in the example described, and in any case similar to that of the parts 12 and 11, as will be explained more fully in what follows with reference to FIG. 2, and on the inside has the shape of a mobile-communication terminal 15, with respect to which it has dimensions of the rectangle that are slightly greater so as to enable housing of said terminal 15 inside it.

The height of the bottom drive portion 13 along the axis Z is likewise substantially comparable to that of a mobile terminal 15, slightly greater so as to enable housing of the terminal 15 inside it. The portions 12 and 11 stacked on the bottom drive portion 13 preferably have corresponding external perimeters in the horizontal plane XY, even though they have much greater heights in the direction Z, so that the printing apparatus 10 presents, in the assembled configuration, like a parallelepiped having vertical walls along the axis Z without any pronounced discontinuities. The outer perimeter has, in the non-limiting example shown, rounded corners; i.e., the sides of the rectangle are connected by arcs of a circle. Of course, since it is the outer perimeter, it is possible for the rounded corners to be present and the vertices of the parallelepiped to be sharp, or vice versa, for the rounded corners to have a larger radius of curvature.

FIG. 2 is an exploded view of the vat portion 12 and of the bottom drive portion 13. The vat portion 12, which, as has been mentioned, has a parallelepipedal shape, comprises within it a rectangular through hole between the top face and the bottom face of the vat portion 12, i.e., between the horizontal faces of the parallelepiped, which defines a growth vat 121. Since this growth vat 121 has a height much greater than the depth of the growth liquid that it contains, it also has the function of shielding the contents from disturbance of a possible environmental lighting, which could interfere with the resin and/or with the light projected by the screen 151 onto a print surface 114.

The growth vat 121 is closed at the bottom face of the vat portion 12 by a membrane 122, possibly removable for being washed and/or replaced, that functions as bottom of said growth vat 121, which otherwise, as has been said, would be open also at the bottom. At the top face of the vat portion 12, the growth vat 121 is instead open, thus having a rectangular opening 123. Hence, the growth vat 121 is associated to the membrane 122, made of transparent or translucid plastic material, for example polyethylene, polytetrafluoroethylene (PTFE), or silicone resin, possibly provided with polarizing capacity, and set on the bottom of the vat to protect the display 151 of the mobile terminal 15 of the user, and is designed to contain a growth liquid, i.e., a printing resin, which is designed for formation of the print product.

The membrane 122 set between the display 151 and the bottom of the portion 12, in addition to protecting the display, as a result of its own flexibility/elasticity moreover solves the known problem, which is common to all other photopolymer printers, of possible adhesion between the solidified polymer and the surface itself. It in fact facilitates detachment from the bottom surface of the vat 121 of the print product being grown as a result of linear (progressive) detachment, and not of planar (simultaneous) detachment, of the print product from the aforesaid bottom surface in strict contact with the mobile terminal 15.

In this regard, the growth liquid, i.e., the resin or photopolymer, in the liquid state, has properties of strong cohesion and weak adhesion. As the resin is transformed from the liquid state to the solid state, the properties of cohesion and adhesion are reversed, and consequently, corresponding to a reduction in the force of cohesion is a stronger adhesion, this characteristic being typical, for example, of many bi-component resins used in the sector of composites (for instance, in the RTM—Resin Transfer Moulding—technique). Since the new solidified layer comes to occupy a position between two surfaces set at a very short distance apart, i.e., the distance between the surface of resin previously solidified and the radiating surface, corresponding to the zero plane, namely, the side facing downwards of the print surface 114, this determines an effect of sticking at a chemico-molecular level on both of the surfaces, an effect that is desirable for the surface belonging to the previous growth layer, but is instead undesirable for the face of the print surface 114 above the membrane 122. Moreover, on account of the physical phenomenon of filming between two surfaces set close to one another, the surface tension of the resin creates a further opposition effect (suction-cup effect). In order to overcome these two forces that both oppose detachment of the print surface from the membrane 122, the membrane 122 itself is made of a material with very low wettability coefficient, i.e., a material with anti-adherent surface. In addition, the membrane 122 is flexible. By way of example, the membrane 122 is sized and tensioned to bend in its central point at least for more than twice the depth of the growth layer; hence, considering a growth layer with a depth of between 1 and 3 mm, it should bend by at least more than 0.2 mm. Reference is here made to a smartphone with a screen measuring 12×6 cm. In embodiments of the printing apparatus, the membrane 122 is flexible at the centre so as to bend by an amount of between 2 and 100 times the depth of one growth layer. In further embodiments of the apparatus, the flexibility of the membrane 122 is between 2 and 40 times the depth of the layer; in further embodiments, it is between 5 and 40 times the depth of the layer; in yet further embodiments, it is between 0.2 mm and 3 mm. Bending of the membrane 122 causes progressive detachment of the solidified layer. As when unwinding adhesive tape, by detaching just one end that advances with an angle greater than 0° between the surfaces, it is possible to separate the film of resin just solidified with little effort. Instead, if the membrane were to be detached all at once with an angle of incidence of 0° between the surfaces, it would oppose a very strong adhesive force.

According to a variant embodiment of the solution described herein, it is envisaged that the growth liquid, i.e., the resin, which is usually poured into the vat 122, in a measured amount, from a flask that in general contains a large amount of resin for a number of printing processes, is supplied in a package with pre-dosed amounts in cartridge or blister format, i.e., in a container having a shape that is suitable for being inserted into the growth vat 121 at its bottom opening that faces the driving portion 13 and the terminal 15, the bottom of the vat being constituted by the flexible membrane 122. In this case, the package in cartridge or blister format and the membrane 122 are of a disposable type.

The bottom drive portion 13 comprises, instead, a support 131, having the shape of a rectangular frame, provided on the top face of which is a projection 132 that runs all along the rectangular frame 131. The projection 132 has a width and height such as to constrain a proper coupling with the element 12 and house, within its smaller perimeter, which delimits an area 133, a mobile terminal 15, once again in the form of a rectangular frame, with dimensions suited to supporting and housing the mobile terminal 15, when this is rested in the horizontal position, i.e., with its own main plane lying in the horizontal plane XY, its own bottom face, namely, the one not provided with the display screen 151, housed within the area 133, and the screen 151 facing the inside of the growth chamber (for example upwards), so as to face, in the assembled position, the outer face of the surface of the membrane 122 and be in contact therewith. A recessed groove 134 in the projection 132 (in the figure, on one of the short sides of said projection 132) enables connection of the mobile terminal to the power-supply/data cable 14. When the mobile terminal 15 is housed in the support 131, it defines, together with the latter, the bottom drive portion 13, which provides both the images for exposing and solidifying corresponding growth layers LAᵢ of photopolymer in the growth vat 121, i being the index of the i-th layer in an incremental sequence of layers LAᵢ, LAᵢ₊₁ that constitute as a whole the three-dimensional print product, and the driving commands for the actuating portion 11, which translates vertically, in response to particular actuation commands SA, in order to move the print surface 114, which translates in a way co-ordinated and alternating with the steps of solidification of the growth layers LAᵢ obtained via exposure to the light emitted by the screen 151.

There are moreover envisaged further movements beyond the depth of the growth layers LAᵢ, which are dedicated to perfect detachment of the surface 114 and to enabling the photopolymer to flow easily into the area dedicated to the next printing layer.

The area 133 that houses the terminal 15 is sized for housing a terminal 15 including the frame around the screen 151, and hence has larger dimensions than the membrane 122. The frame 133 is preferably sized for housing up to the largest mobile terminal 15 within a given category of mobile terminals suited to being integrated in the printing apparatus 10 and may be shaped for specific apparatuses.

Inserted within the area 133, which preferably corresponds to a through opening in the frame 131, is a rectangular cushion 133a of a shape corresponding to that of the area 133. This cushion 133a has functions of stabilization of the mobile terminal 15 with respect to the membrane 122, as well as of damping of the vibrations on the mobile terminal 15, and anti-slip functions with respect to the surface on which the printing apparatus 10 rests. For this purpose, as shown in the figure, it may comprise pads 133b or bumps made of shock-absorbing and/or anti-slip material, such as rubber or neoprene. The cushion 133a may in turn be made of shock-absorbing and/or anti-slip material.

The above mobile apparatuses are commonly grouped into categories according to their size: these categories include smartphones, tablet PCs, mobile PCs, convertible PCs, etc. Each of these categories have in common the fact that the reference mobile devices integrate a screen, an operating system, a graphics card, the possibility of remote connection via Wi-Fi/Bluetooth/USB/SIM/Ethernet, etc., the possibility of reproducing sounds, and the possibility of being battery-supplied, and differ from one another as regards size and association or otherwise of a physical keypad (instead of, or in addition to, the touch screen). In the case of smaller mobile terminals, they may be housed by means of the adapter set in the area 133. In the case of mobile terminals of dimensions larger than the three-dimensional-printing apparatus 10, above all in the horizontal plane, the apparatus 10 may comprise a drive portion 13 that is reduced to the terminal 15, to a support comprising the cushion 133a for stabilization of the mobile terminal 15, underneath which the latter is set, and, possibly, to means for fixing the growth vat 12, such as for example suction cups on the bottom edge of the vat, or adhesive pads and/or pads made of anti-slip material for fixing the edge of the vat 12 and/or the membrane 122 to the screen 151. The mobile terminal 15 may, however, exceed, as regards dimensions of the screen, the maximum dimensions compatible with the membrane 122, without thereby jeopardizing in no way operation of the machine: the final effect is simply that the maximum printable area—where this area is defined by its own dimensions in width and depth (X-Y)—is equal to or smaller than the native area of the screen. Consequently, according to the present disclosure, by “mobile terminals” are meant not only the ones known as “smartphones” but also those referred to as “tablets” and the like (as described previously), without prejudice to the technical characteristics set forth previously as regards computational capacity, wireless connectivity, and representation via a display screen.

Of course, in variant embodiments, the printing apparatus 10 may have dimensions, in particular in plan view, corresponding to those of larger mobile terminals, for example tablets, with 10-inch screen or more, maintaining the structure of FIG. 2, with a portion 13 comprising the frame 131.

Also the growth vat 121 and the membrane 122 are preferably sized with respect to the dimensions of the largest screen of a range of mobile terminals compatible with the apparatus 10. In fact, mobile terminals with smaller screens simply expose a smaller area on the bottom of the vat 121 and possibly limit the maximum size of the product that can be obtained. The terminals with larger screens, instead, do not use the entire display area, but only a fraction thereof equal to or smaller than the area of the membrane 122.

The support 131 operates as element for stabilizing the mobile terminal 15 and attenuate any possible irregularities of the resting surface on which the entire printing apparatus 10 is located. It is configured, via a corresponding seat, for receiving the possible supply cable 14 and operates as element for closing the stack of elements 11, 12, 13 to obtain a better darkening of the inside of the growth vat 121.

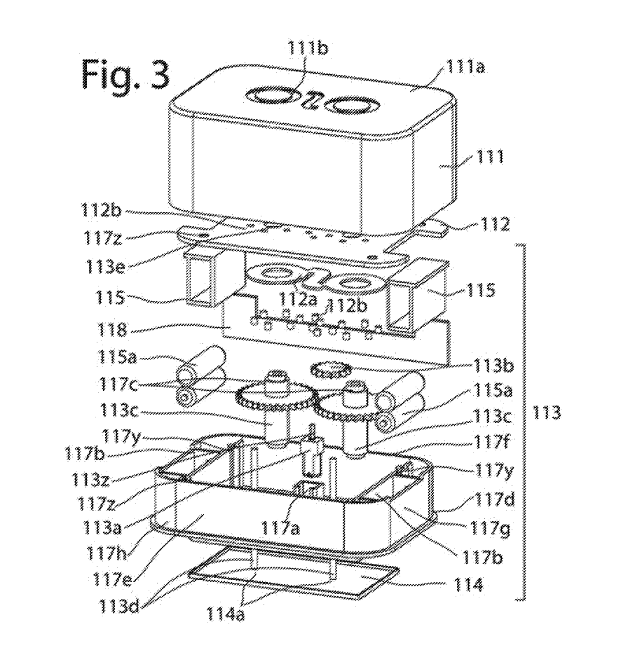

FIG. 3 is, instead, an exploded view of the top, actuating, portion 11. It comprises a top guard 111, i.e., a parallelepipedal housing with rectangular base similar to that of the median, vat, portion 12 or bottom drive portion 13, which comprises a top surface 111a or roof, whereas the bottom surface is open, bestowing on the top guard 111 the shape of a covering hood, to enable housing in said top guard 111 of the remaining components of the actuating portion 11, described hereinafter.

Provided on the top surface of the top guard 111 are slits 111b in the form of a logo or graphic symbol. Provided underneath the top surface 111a of the top guard 111 is an element 112, which has a substantially flat shape with major dimensions compatible for fitting in the top guard 111 and faces the inside of the top surface 111a and in particular faces the element inside the top guard 111, which comprises on its top surface a translucid element 111c, having a shape and a position such as to correspond to that of the slits 111b, i.e., having the shape similar to the aforesaid logo or symbol, so that, by applying the internal element 112 together with an actuation module 113 described hereinafter from underneath the inner roof surface 111a of the top guard 111, the translucid element 112a comes to fit into said slits 111b, substantially constituting a translucid screen inserted in the aforesaid top roof surface 111a. The element 112 may further comprise LEDs 112b, which can be switched on for lighting portions of the translucid element 112a. Hence, the ensemble constituted by the LEDs 112b, the translucid element 112a, and the slits 111b defines a backlit translucid element, which, through emission of light signals, informs the user on the state of the process in progress in the printing apparatus 10, for example through different time ON/OFF or fade-in/fade-out sequences, also obtained by varying the on-off frequency or power.

Provided underneath of the internal element 112 is an actuation module 113, which comprises in the first place a motor 113a, the shaft 113z of which turns about a vertical axis and comprises on said vertical axis an element for transfer of motion 113b, which in the figure is a gear wheel but may alternatively be also obtained via a pinion, a crown-and-pulley system, or a worms crew.

The actuation module 113 is configured to move the print surface 114 in the vertical direction, i.e., orthogonal to the plane of the print surface. This vertical actuation is particularly advantageous in the apparatus described in so far as it enables the actuating portion 11 to be positioned at the top with respect to the terminal 15 and with respect to the bottom drive portion 13. For this purpose, in the example shown, the actuation module 113 comprises two wormscrews 113c, in a vertical position, translating within which are two respective threaded elements 113d, which are designed for translation and transfer of motion along the vertical axis z and are connected at their bottom end in a fixed way with respect to the print surface 114.

It should be noted that the internal element 112 comprises two holes 113e, with function of plain bearing or bushing, which are made of the same plastic as the wormscrews 113c, and in which the top ends engage when the actuating portion 11 is assembled.

When the top, actuating, portion 11 is assembled, the gear 113b is substantially at the same horizontal height as the crown wheels 117c and transmits motion simultaneously to both of the elements for transmission of motion 113d, setting in rotation the two wormscrews 113c, which, hence, according to the direction of rotation of the motor 113a, lower and raise accordingly the bottom ends of their threaded stems 113d. The stems 113d are connected, at the aforesaid bottom ends, to a print surface 114. The print surface 114 is represented by a rectangular plate having a shape corresponding to the section of the growth vat and may comprise on its underface electro-conductive spots 114a, which can be used for carrying out auto-setting of the zero printing level, with a display 151 of the resistive or capacitive touch-screen type. The aforesaid print surface 114, as has been said, is coupled to the wormscrews 113c, which are able to displace along the perpendicular to the display 151 of the mobile terminal 15 along the vertical axis Z and are actuated by the motor 113a/gear 113b system, which is fixed with respect to the motor/reduction gears 113d/wormscrews 113c/threaded stems 113d. Of course, any other electro/mechanical system that is designed to guarantee linear translation of the print surface 114 along a vertical axis with respect to the horizontal plane of the vat 121 and in the direction of the screen 151 may be used. Represented on the two sides of the actuating portion 11 are two battery compartments 115 with corresponding batteries 115a, which are set in corresponding housings 117b in a bottom guard 117, which will be described more fully hereinafter. These batteries 115a supply the electric motor 113a, an electronic control board 118, and the LED lights 112b. Designated by 118 is the electronic control board of the actuator module, the functions of which will likewise be described in greater detail in what follows. Visible in FIG. 3 is a bottom guard 117, which substantially comprises a rectangular body, with outer section in the plane having a shape such as to fit with tolerance in the bottom opening of the top guard 111. The bottom guard 117 is open both in its top face and in its bottom face, where it has on the outside a projecting edge 117d. In the assembled position, the bottom guard 117 fits into the top guard 111 until the edge of the bottom face of the latter comes to bear on the projecting edge 117d. As shown in the figure, the bottom guard 117 comprises inside four vertical threaded bushings 117z, to enable fixing, via screws, of the internal covering guard 112 to the bottom guard 117, the bushings 117z comprising holes in corresponding positions in the horizontal plane. As may be noted from FIG. 3, the bottom guard 117, like the top guard 111, has a rectangular shape with rounded corners in plan view, where the sides are rectilinear, 117e being the rectilinear front side, 117f being the rectilinear rear side, 117g being the minor sides. These sides are connected to one another by elements shaped like an arc of a circle 117h that subtend an angle of 90°, at the corners. The threaded bushings 117z are, more specifically, located at the ends of the aforesaid rectilinear parts so that identified between the short sides 117g and the bushings 117z is a space, which, via partition walls, identifies the housings 117b for the batteries. Set, instead, along the rear wall 117f is a housing 117a for the motor 113a. The control board 118 is housed in a slot 117y in a position corresponding to the two bushings closest to the rear wall 117f.

Hence, the three-dimensional-printing apparatus 10 in general envisages, for its operation, use of the mobile terminal as light source, set underneath the growth vat 121, for exposing the growth liquid. For this purpose, the printing resin used by the apparatus 10 is represented by a photopolymer, solidification (curing) of which is obtained by exposure to the visible light. As is known, the three-dimensional-printing apparatus operates by growth of layers, hardening or solidifying, through exposure to light, for example of a laser, a photopolymer according to an image or pattern representing the horizontal section of the three-dimensional print product that is to be created. In the printing apparatus 10, it is the mobile terminal 15 that is configured for displaying on its own screen 151 an image representing a growth layer. The print bed 114 raises by adhesion, under the control of the motor 113a, which is in turn controlled by the control board 118, the solidified growth layer, which is located on the bottom of the growth vat, by a pre-defined distance, and the terminal 15 displays the next growth layer. Hence, according to a first aspect of the solution described herein, the three-dimensional-printing apparatus 10 is configured for housing the screen of a mobile terminal underneath the growth vat in such a way that the screen will operate as light source to define the growth layers on the bottom of said growth vat.

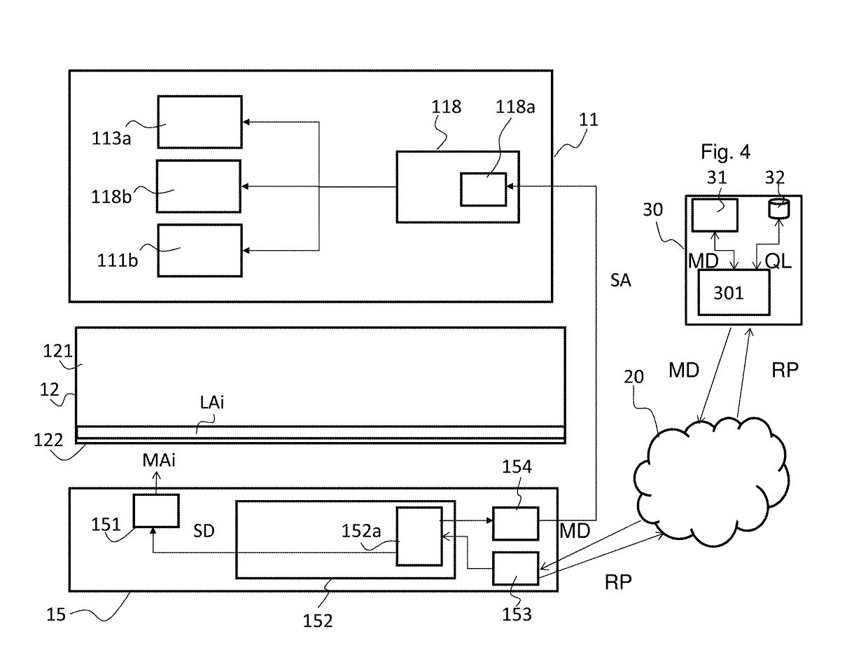

FIG. 4 shows a printing system that operates via the printing apparatus 10. For this purpose, the apparatus 10 is represented schematically through some of its logic modules. In particular, the mobile-communication terminal 15 is shown, which comprises a microprocessor 152, in general the processor of the mobile terminal for carrying out the functions proper to the mobile terminal, whether they are sound and communication functions or specific software applications such as word processing, navigation, games, or the like. This microprocessor 152 is configured, in particular, for loading and executing a printing application 152a. A module is shown corresponding to the screen 151, which is managed by the microprocessor 152, in a way in itself known to the person skilled in the sector. Moreover, a mobile-communication module 153 is represented, i.e., a transceiver, for example a 3G UMTS transceiver, for connection to a communication network 20, which hence, in the example, is also a 3G mobile-communication network. Of course, the mobile-communication terminal 15 and the mobile-communication network 20 may operate according to other mobile-communication standards, for example GSM, just as in general, the connection may alternatively occur via a Wi-Fi transceiver, instead of the 3G transmitter, and a WLAN as mobile-communication network, which then enables access to further external networks, in particular to the Internet. Via the mobile-communication network 20 a server 30 is hence in general accessible, through one or more data-communication networks.

The mobile-communication terminal 15 further comprises a second signal transmitter 154. This signal transmitter 154, according to a preferred embodiment, is represented by the audio peripheral or audio output of the mobile terminal 15 for transmitting actuation signals SA, of an ultrasound acoustic type, to the control board 118 of the actuating portion 11, at frequencies of approximately 20 kHz or at ultrasound frequencies.

The above electronic control board 118 hence comprises a signal receiver 118a configured for receiving commands sent by the mobile terminal 15 via the actuation signals SA, in the example a receiver suited to receiving acoustic signals at the frequency of 20 kHz and/or ultrasound frequencies, in particular in a range from 20 kHz or more, in particular up to 24 kHz. It should be noted that, in general, the audio peripherals of the mobile terminals 15 are in themselves able to emit ultrasounds at a frequency of approximately 20 kHz, which can hence be used for transmission by the transmitter 154. In the case where the specific model of the mobile terminal, owing to technical limits of its own, were not able to receive signals at said acoustic and/or ultrasound frequencies, the system is configured for making the communication at higher or lower frequencies, until it finds the most suitable one, which could hence also be perceivable by the human ear, like the heading procedure of analog data modems.

To the electronic control board 118 there may moreover be associated a light-intensity sensor 118b, set in the bottom guard 117, but not shown in the previous figures, which measures the light intensity emitted by the display 151 of the mobile terminal 15.

The control board 118 operates mainly as controller of the motor 113a, in particular driving the motor 113a, under the control of the actuation signals SA sent by the mobile terminal 15 through the communication channel between the transmitter 154 and the receiver 118a. The control board 118 moreover operates as controller, managing turning-on and turning-off of the aforesaid LED lights 112b.

Hence, in general, the three-dimensional-printing apparatus 10 comprises an ensemble of hardware elements, i.e., the top, actuating, portion 11 and the median, vat, portion 12, associated to a bottom drive portion 13, which comprises an element for driving the apparatus, with the capacity of functioning both as light source and as control module of the actuating portion 11, which is identified by the support 131 that removably houses the mobile-communication terminal 15.

The mobile terminal 15, according to the solution described herein, contributes as hardware element, namely, the light source for solidification of the photopolymer of the growth layers LAᵢ, and as a software control module, namely, the printing application 152a. This printing application 152a is configured as a client application with respect to a server application 301a located in the server 30. The server 30 is not in general a single server computer, even though this configuration is of course possible, but is preferably obtained via a plurality of computers that operate according to the cloud-computing paradigm.

Hence, the three-dimensional-printing apparatus 10 is configured for operating in association with a mobile terminal 15, which may be a smartphone, or a tablet, or a terminal of any other kind simultaneously comprising:

a screen, for example the screen 151;

a microprocessor computing structure, for example the microprocessor 152, which provides computational and data-processing capacities, as well as enabling management of an operating system and of peripherals; and

connection and communication capacity on wired or wireless data networks, in order to operate as device for three-dimensional printing of polymeric resins photoactivated by sources of light within the visible spectrum.

In this way, the mobile terminal is transformed into a 3D-printing device that uses premixed photopolymers in liquid form (resin), which are able to harden (photoactivated catalyzation) when exposed to a light source in the visible spectrum (spectrum of the light emitted by the display of the mobile terminal).

The printing application 152a of a client type installed on the mobile terminal 15 uses: connection of the mobile terminal 15 to the data network, for example the 3G transceiver 153, for access to the contents and to functions housed in the server 30; and the processing and computational capacity of the mobile terminal 15 for interfacing, for example through the transmitter 154, with the electronic control board 118 of the actuating portion 11, sending actuation signals SA that manage:

linear movement of the print surface 114 in time, enabling, for example, actuation of its linear displacement along the axis Z, controlling the degree of the displacement and the direction of the displacement by governing
a period of time between the displacements of the print surface 114,
a value of increment of displacement along the axis Z,

execution of periodic movement routines for detachment of a growth layer from the membrane 122;

other service-movement routines (for example, cleaning-cycle routine or end-of-printing-cycle routine);

a synchronisation of the instants in which the print surface 114 is moved with respect to the instants of display in which there takes place light emission for a given mask on the screen 151; this synchronisation manages parameters such as an advance and/or delay of the instant determined by the aforesaid period of time between the displacements with respect to the instant of display by the light source, i.e., the screen 151, as well as possible strategies of illumination and amplification of the details, edges, and fields, and strategies for reduction of optical disturbance and energy saving.

The printing application 152 drives the screen 151 of the mobile terminal 15 so as to expose the first growth layer of resin LAᵢ, on the bottom of the growth vat 121, in contact with the transparent or translucid and/or polarizing membrane 122, enabling incremental growth of the three-dimensional print model (or product) through sequential solidification by layers of resin photo-activated by the visible light emitted by the screen of the terminal 15e.

The printing application 152 is an application compatible with the operating system implemented by the terminal 15; for example, it may be compatible with the mobile operating systems iOS, or Android, or Windows Phone. It enables management, configuration, and control of the hardware functions (for instance, display of images on the screen 151) and software functions of the user mobile terminal 15 for operation of the printer. Sending of the actuation signals SA is preferably carried out via a wireless transmitter, such as the ultrasound channel 154, or also via a Bluetooth signal or other electromagnetic signal, or wireless signal that propagates also through the structures of the apparatus 10, by providing a corresponding receiver in the control board 118. If there is a free optical path, a wireless optical transmitter may alternatively be used. Falling within the scope of the solution described herein is, however, in variant embodiments, also the possibility of wired communication for sending the actuation signals SA, using a cable that connects the transmitter actuation signals SA to the control board 118. Both analog and digital channels may be used for sending the actuation signals SA. By sending the actuation signals SA, the printing application 152 communicates to the actuating portion 11 the commands necessary for management of the three-dimensional-printing process and moreover controls the LEDs 112b incorporated in the actuating portion 11 with function of feedback interface for the user, for supplying, for example, information on the status of the printer that can be immediately understood by the user.

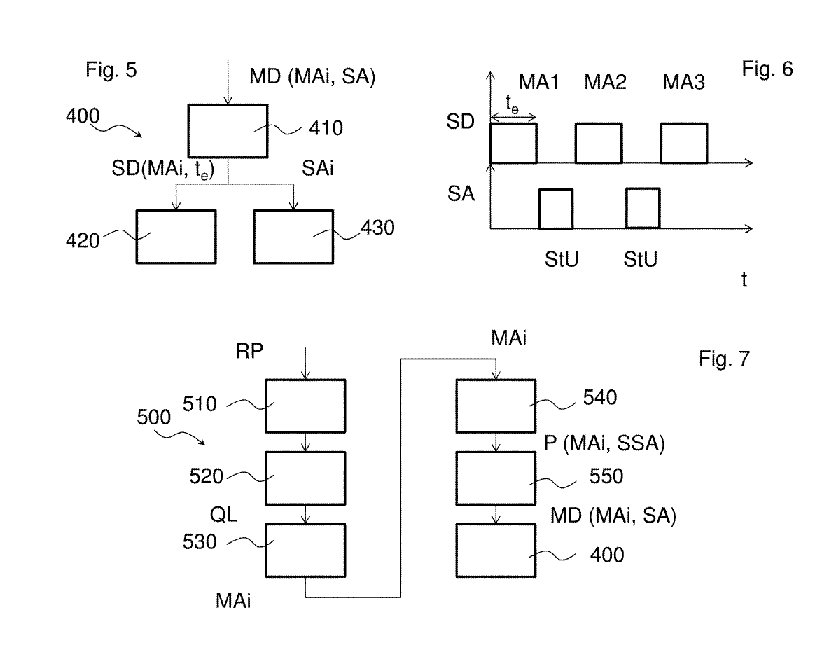

FIG. 5 is a flowchart representing a printing procedure 400 carried out by the printing application 152a. In a step 410 the printing application 152a receives a digital model MD. A digital model MD basically comprises an orderly sequence of masks MAᵢ, ordered according to an index i, which correspond to the growth layers LAᵢ, and a series of movement commands CM, for example commands according to the known G-code standard or as a series of known “M functions” (pre-set machine macro-functions) that drive the movements of the actuators for starting printing during exposure of one mask MAᵢ, of the next one MAᵢ₋₁, and in the final step. This is the general approach, even though movements of the actuator can be carried out also during exposure of the mask MAᵢ. The digital model MD can incorporate also other metadata, for example the descriptive metadata regarding the display parameters, such as an exposure time tₑ for the masks MAᵢ, or regarding the resin being used, in addition to the characteristics of the mobile terminal. The printing application 152a hence generates a display signal SD, which comprises the sequence of masks and the display parameters as a function of time, as shown in the timing chart of FIG. 6, which is sent to the screen 151 for display 420. Shown in this figure are the periods of display of masks MA1, MA2, MA3 for a not necessarily periodic time of exposure tₑ, separated by off intervals. The printing application 152a moreover generates, on the basis of the movement commands CM, the actuation signal SA for the control board 118, which governs a linear actuation 430 of the print surface 114 through the actuation module 113.

Specifically, via the actuation signals SA the following movement functions are managed totally or partially:

procedure of “ZERO” auto-setting of the print surface; in said context, the print surface 114 is actuated for sending it to its bottom end-of-travel position, if necessary with the aid of the conductive spots 114a in order to make sure that it is in contact with the screen 151, which is preferably a touch screen, of the mobile terminal 15; the touch screen 151, through the integrated control card of the touch screen itself, preferably emits a zero contact signal to the printing application 152a, which controls the actuating portion 11; this zero contact signal confirms that there has occurred contact of the actuating portion 11 downwards, and requests recession by a certain pre-defined number of steps (STEP commands, defined in what follows), to be able to start off the printing process; this operation is also replaced or assisted by purposely provided end-of-travel sensors set at the top end of the actuator 11, and in particular on the control board 118, especially if a terminal with touch screen is not available;

execution of a “HOME” command, which brings the print surface 114 into the starting position—position of maximum return upwards, or top end-of-travel position;

execution of a “CLEANING” command, via a cycle of predefined movements of the surface 114;

execution of an incremental or decremental “STEP” command for moving the surface 114 forwards or backwards, i.e., downwards or upwards by a given distance or step or predefined series of steps; this STEP command, which is specifically incremental, is designated by StU in FIG. 6;

execution of other routines for technical setup of the actuating portion 11; and

management and light-feedback control via the LEDs 112b on the top guard 111 or other surface of the apparatus 10.

Hence, in the diagram of FIG. 6 it may be noted how during each off interval, between the exposure intervals tₑ, which are not necessarily homogeneous as regards length and/or intensity of the display signal SD in each exposure interval tₑ, the printing application 152a will send for example incremental “STEP” commands StU, so as to raise the print surface 114 by a given distance, in particular corresponding to the depth of a new growth layer LAᵢ. The example provided in FIG. 6 is very simple, but it is clear that the actuation commands SA may be more complex to get the print surface 114 to follow more complex paths. For example, in many applications, between exposure of one mask MAᵢ and exposure of the next, the surface 114 is actuated so as to rise by a given distance and is then lowered again by a smaller distance, the difference between these distances being equal to the depth of a growth layer so as to enable a faster and more uniform filling. Likewise, the exposure time tₑ is not necessarily the same for all the layers.

The printing application 152a is moreover configured for managing the functions of communication with the server 30 in the context of the printing functions; for example:

it accesses a library of digital models 31 on the remote server 30 for selection of a digital model MD to be printed (these models may, for example, be three-dimensional models, two-dimensional models, vector raster models, video models, audio models, etc.);

it comprises functions for creation of a digital model MD in a library 31 of three-dimensional models on the remote server 30 and for modification of a digital model MD already in the library in order to enable personalization thereof;

it comprises functions for setting the type of material, in particular photopolymer, that is to be used for printing;

it carries out functions for informing the user on an amount of resin QL and a time necessary for concluding successfully the process of three-dimensional printing of the model MD chosen; this information preferably resides in a technical-information database 32 in the server 30;

it comprises functions for gathering information on the printing apparatus 10 and sending it to the server 30, such as the type of mobile terminal 15 and/or photopolymer used;

it comprises functions for starting printing of the model MD on the printing apparatus 10 or else for sending the selected/modified/created model MD (which may even be incomplete) in the library on the server 30 of another user possibly provided with the apparatus 10 or a compatible apparatus through integrated messaging functions or functions compatible with other known electronic communication systems;

it comprises functions for inviting its own email/social-network contacts to form part of a social group/community of users of the printing apparatus 10;

it comprises functions for exchanging messages and three-dimensional models between users, in particular between users of the social group/community of the printing apparatus 10; the three-dimensional digital models MD, i.e., for example a packet P thereof as described in greater detail hereinafter, are not, however, attached to the message as if it were an email message; instead, these messages, which may be SMS (Short Message Service) messages, as likewise messages of messaging systems such as WhatsApp or Skype, contain an access code, preferably encrypted; the application 152a of the recipient terminal is configured, following upon reception of this access code, in particular a metadatum of the messaging system, for accessing a print request RP of the digital model MD for the server application 301, which is described more fully in what follows with reference to a remote printing procedure 500 in FIG. 7; in general, via this request RP, after prior acknowledgement of the terminal 15 of the user that receives the message, and of the type of resin, a data packet with this information and the request is sent to a library, i.e., the library 31 of the models MD in compressed format useful for starting production; the file of the actual digital model MD is housed in the server 30 in a personal space of the sender in the library 31 and possibly shared (temporarily) with the addressee.

In greater detail, the “3D messaging” service envisages, for example, the possibility of sending a so-called three-dimensional or 3D message via an Instant Messaging message transmitted via Internet-technology networks through a cloud-based architecture, and in particular by a system that is based upon one or more dedicated servers (according to a client>server>client sequence). The printing procedure via 3D messaging specifically comprises:
composition and sending by a sender of a text message attached to which is a 3D display file, which is in general a display file in a proprietary format representing the digital model MD that is to reach the recipient, whose display experience is similar to the one obtained by the format .X3D, or else in X3D format, as well as definition of the addressee: before sending the 3D message, it is possible for the sender to display the model, changing the orientation thereof, as in interactive virtual environments compatible with X3D, with a three-dimensional representation also with the possible addition of colours, shading effects and textures; it should be noted that the actual file, i.e., the packet P with the masks, is not sent by the sender (this advantageously avoiding any need for evaluation of copyright on the model at this stage) but is only displayed just as occurs today with video-streaming services;

after sending of the 3D message, notification (for example, compatible with the push-notification standard), which notifies the addressee of arrival of a 3D message and connection, either automatic or after prior authorisation, of the application 152a to the server and download of the display file together with the text or voice message of the sender: once the addressee has downloaded and displayed the digital model MD, he can then decide whether to proceed and ask the server 30—via the specific application 152a and forwarding of a print request RP—to receive the file optimized for three-dimensional printing, i.e., the packet P, which, as has been said, comprises a sequence of black-and-white “slices” together with a series of metadata designed for control of the printer, and finally proceed to actual production of the piece.

Access to the packets P may take place in an open or protected way, limited in time or via password and may authorize or not the addressee to share the contents with other possible users of the community of the application 152a.

The function is innovative and advantageous, authorised access to the digital model also enabling personalization of the file according to the type of terminal of the addressee.

Moreover, if a digital model is sent to an addressee in the form of a “gift” or “surprise”, the shape of the object will be revealed to the addressee only after the model has been effectively printed in solid form.

Accordingly, the server 30 houses a server application 301 that enables the client 152 to access the library 31 of the digital models MD, whether 2D of 3D, which may contain also further information linked to the models, also known as “paradata”, such as design notes, inspiring material, and more in general whatever the users/clients will deem useful and necessary for realizing three-dimensional printing of their own ideas in the form of models to be printed.

As shown in the flowchart of FIG. 7, where a remote printing procedure 500 is illustrated, in a step 510, the server application 301 receives from the client application 152a a print request RP for printing of the digital model MD chosen/modified/created/received by the user, possibly together with the choice of the printing material, and the number of pieces to be printed.

The server application 301 is moreover configured for carrying out, in a step 520, a printing simulation for determining the optimal amount QL of material (resin) to be introduced into the growth vat 122. This step may be optional if the corresponding information is otherwise available.

The server application 301 is moreover configured for carrying out, in a step 530, discretization in masks MAᵢ corresponding to sequential growth layers LAᵢ, also referred to as “slicing”, of the digital model selected MD. This may be obtained taking into account the user preferences as regards the type of preselected material and the desired level of quality.

Once the operation of discretization 530 is through, in a step 540, the server application 301 sends to the client application 152a a data packet P, in particular a compressed data packet, containing all the masks MAi, i.e., two-dimensional raster images to be reproduced on the screen 151, together with movement commands CM necessary for controlling the movements of the actuating portion 11 in a way co-ordinated with light emission of the masks MAᵢ on the screen 151.

In a step 550, the application 152a extracts the masks MAᵢ and the movement commands CM from the packet P, and then executes the procedure 400 of FIG. 6, displaying sequentially the masks MAi and generating at the same time, on the basis of the movement commands CM, the actuation signals SA for the actuating portion 11. These actuation commands SA may also be a very small set, such as the commands described above (e.g. zero autoset, home set, step set, cleaning mode, etc.), even reduced to just the incremental STEP and decremental STEP described above, which are interpreted by the control board 118, whilst the timing is managed by the application 152a. There are of course possible, on the other hand, more complex sets of commands or sequences.

It should be noted that preferably the printing application 152a, at the moment of execution of the printing procedure 400, is configured for operating in exclusive mode, preventing interruption of its own execution and access to the screen 151 by all the other programs that operate in the terminal 15. In other words, the printing application 152a is configured for controlling exclusively display on the screen 151, preferably in full-screen mode, excluding any visual interference, such as appearance of notification messages regarding emails or SMS messages or phone calls, which would ruin the product being printed. In particular, during the printing procedure 400, all the communication peripherals are de-activated, for example in a way similar to the “offline” mode in mobile terminals, which excludes the communication peripherals in order not to interfere with the aircraft, except for the fact that the specific transmitter 154 used for driving the actuating portion 11 is kept functioning. It thus goes without saying that the aforementioned compressed digital data packet P is entirely downloaded from the server 30 through a print request RP by the client 152a, before the printing process is started and the digital connectivity channels (Bluetooth, Wi-Fi, 3G/4G, etc.) are inhibited. Disconnection from the network 20 becomes necessary because, clearly, the printing process 400, which may even take hours, cannot be disturbed by the appearance of extraneous images on the screen 151.

As mentioned previously, the resin may be poured from a flask in a measured amount calculated in the simulation step 520 and displayed on the terminal 15 via the application 152a; however, in variant embodiments, the resin is contained in cartridges that integrate the flexible membrane 122 as bottom to be set in contact with the screen 151.

In the above embodiments the cartridge or flask may be equipped with a graphic representation that can be read by the terminal 15, for example, a QR code or barcode, indicating the identifier number of the cartridge or flask. The client application 152a can receive from the terminal 15, which decodes the readable representation, for example a QR code, the identifier number. The client application 152a, on the basis of the identifier number of the flask or cartridge, via access to a database comprised in the client application 152a that contains these data, automatically sets the parameters corresponding to the type of growth liquid, or resin, that the user intends to use and recalls the specific variants of printing strategy that are most suited to the model of mobile terminal in use, which take into account, for example, one or more of the following parameters:

technology of the screen 151 (e.g. OLED matrix, AMOLED, or LCD matrix);

resolution;

dot pitch;

absolute size of the screen 151;

decay of light emission linked to the working hours of the terminal 151.

On the basis of the above printing parameters, the lighting and actuation commands may be configured or changed. For example, on the basis of the decay of light emission, it is possible to project each mask image for a longer time.

It is also provided that the client application 152a will send to the server application 301 such identifier number on the flask of the growth liquid and will obtain from a database of its own information regarding the type of growth liquid in use, the identifier code of the package, and the production lot. The server application 301 may update this database of the flasks, storing in a form regarding the flask identified by the identifier number read from the QR code the residual amount of growth liquid in the flask, in addition to guaranteeing the user on the authenticity and genuineness of the material being used. The value of residual amount of liquid, associated to a tolerance value, is stored.

Moreover, the server application 301 may receive from the client application 152a also the printing parameters referred to above, i.e., the information regarding the model and obsolescence of the mobile terminal used.

According to a further aspect of the solution described herein, it is envisaged to carry out a procedure of pre-heating of the photopolymer in the vat 121. In fact, it is known that by heating the photopolymer its viscosity and ease of passage from liquid to solid state increases, with better results in terms of success of the print, quality, and speed. This procedure envisages exploitation of the heat emanating from the mobile terminal 15 for heating the photopolymer, and consequently, according to a variant embodiment, the membrane 122 is of the type enriched (either by doping or by addition of fillers) with conductive nanoparticles, in particular metal, which are designed, on the one hand, to improve transmission and diffusion of heat and, on the other, to optimize the electric resistance of the sensors 114a.

The apparatus described presents the advantages listed hereinafter.

The apparatus described is advantageously configured for associating the growth vat and the actuator module of an apparatus for three-dimensional printing by photopolymerization to the screen of a mobile terminal. In this way, integrated in one and the same removable element are: the light source of mask images and the driving module of the apparatus both in terms of generation of the mask images and in terms of co-ordinated movement of the print surface via the actuator.

In addition, advantageously, the adoption of a mobile terminal means that it can receive the digital models from a remote server together with the instructions for driving the printing apparatus.

Of course, without prejudice to the principle of the invention, the details and embodiments may vary, even significantly, from what has been described herein purely by way of example, without thereby departing from the sphere of protection, which is defined by the annexed claims.

1. An apparatus for three-dimensional printing of three-dimensional products operating by solidification, through light radiation, of successive layers of a growth liquid comprising a photopolymer that can be solidified by action of said light radiation, including a growth vat, operated by vertical actuation, for growth of the print product, said vat being designed to contain said growth liquid, an actuating portion associated to a print surface designed to adhere to a layer after solidification in order to move the print product during growth in said growth vat, a light source facing a side of the growth vat through a membrane, for emitting said light radiation (MAᵢ), and a control module for sending actuation command signals for driving said actuating portion;
said printing apparatus being wherein it includes a print drive portion configured for housing in a removable way a mobile-communication terminal, which includes a screen designed to display images set in such a way that said screen faces the side of the membrane on the side of said growth vat in such a way as to operate as source for emitting said light radiation, said photopolymer being of a type that can be solidified by the light radiation emitted by said screen, in particular by radiation in the visible range, said mobile terminal being moreover configured to operate as control module for sending actuation command signals to said actuating portion.

2. The apparatus according to claim 1, wherein said actuating portion comprises an actuation control board, and said control board comprises means for receiving actuation command signals sent by corresponding transmission means provided in the mobile terminal.

3. The apparatus according to claim 1, wherein said transmission means include an audio speaker of the mobile terminal, which modulates said actuation command signals at acoustic and/or ultrasound frequencies, said receiving means including microphones designed to receive signals at said at acoustic and/or ultrasound frequencies.

4. The apparatus according to claim 1, wherein said mobile terminal is configured for accessing a remote server, which includes a library of models, and for loading a model from said library, and movement commands associated to said model, said mobile terminal being moreover configured for sending to said actuating portion actuation command signals obtained on the basis of said movement commands associated to said model.

5. The apparatus according to claim 1, wherein said model includes an orderly sequence of images corresponding to said sequence of successive layers and in that said mobile terminal is configured for extracting from said model said images and for displaying them sequentially on the screen according to a time sequence indicated in the movement commands associated to said model and moreover for sending to said actuating portion actuation commands, which control the movement of the print surface, and in particular synchronize the latter with respect to the images displayed on the screen.

6. The apparatus according to claim 1, wherein said membrane is a membrane that is designed to transmit said visible light radiation and is flexible, in particular flexible in a central point, with respect to a resting position, so that it bends by an amount equal to at least the thickness of two growth layers, in particular said membrane being made of polyethylene or polytetrafluoroethylene or silicone resin.

7. The apparatus according to claim 1, wherein said membrane includes conductive nanoparticles.

8. The apparatus according to claim 1, wherein said growth liquid is contained in a container, which can be introduced into said growth vat and has a bottom part including said membrane.

9. The apparatus according to claim 1, wherein said radiation is in the visible spectrum emitted by an organic-light-emitting-matrix or LCD screen and in that said photopolymer is sensitive to the visible spectrum.

10. The apparatus according to claim 1, wherein said actuation module is configured to move the print surface in the vertical direction, in particular via one or more wormscrews connected to said print surface.

11. A printing architecture including at least one apparatus according to claim 1, wherein it comprises a remote server including a library of digital models.

12. A method for three-dimensional printing of three-dimensional products operating by solidification, through light radiation, of successive layers, wherein it includes the operations carried out by the apparatus according to claim 1.

13. The printing method according to claim 12, wherein:
receiving, at the terminal, a digital model, which includes an orderly sequence of masks, which correspond to the growth layers, and movement commands to be generated at the terminal;
a corresponding display signal, which includes the orderly sequence of masks and display parameters as a function of time for the screen of the receiving terminal, which displays said masks; and
an actuation signal for said actuating portion for performing an actuation operation, in particular linear actuation of the print surface.

14. The printing method according to claim 13, wherein it includes a remote printing procedure, which comprises: receiving, at the server, in particular via a server application, from the terminal, in particular from a client application, a request for printing a digital model,
carrying out, at the server, a discretization into masks corresponding to sequential growth layers of the digital model requested;
sending, by the remote server to the mobile terminal, a data packet, in particular a compressed data packet, containing the masks together with movement commands necessary for controlling the movements of the actuating portion in a way co-ordinated with light emission of the masks by the screen of the mobile terminal; and
extracting, at the terminal, said masks and movement commands, and then carrying out the printing procedure at the apparatus.

15. The printing method according to claim 14, wherein receiving, at the terminal of a recipient user, a digital message including code configured for sending a given print request, in particular configured with data of the receiving terminal and/or of the associated printing apparatus, and for sending a printing procedure.

16. A computer program product, which can be loaded into the memory of at least one computer, the computer program product comprising portions of software code for implementing the method according to claim 12 when it is run on said at least one computer.
